(19) United States
(12) Patent Application Publication
(10) Pub. No.: US 2020/0311683 A1
(43) Pub. Date: Oct. 1, 2020

(54) SIMILARITY-BASED SEQUENCING OF SKILLS

(71) Applicant: Microsoft Technology Licensing, LLC, Redmond, WA (US)

(72) Inventors: Pei Ying Chua, Singapore (SG); Akash Kaura, Singapore (SG); Paul H. Ko, Brooklyn, NY (US)

(73) Assignee: Microsoft Technology Licensing, LLC, Redmond, WA (US)

(21) Appl. No.: 16/367,709

(22) Filed: Mar. 28, 2019

(51) Int. Cl. G06Q 10/10; G06K 9/62; G06F 17/27

(52) U.S. Cl. CPC G06Q 10/1053; G06F 17/27; G06K 9/6215

(57) ABSTRACT

The disclosed embodiments provide a system for processing data. During operation, the system determines similarity scores between pairs of skills based on occurrences of the skills in documents. Next, the system determines, based on the similarity scores, a first subset of skills that is similar to a first skill and a second subset of skills that is similar to a second skill. The system then calculates a first normalized similarity score between the two skills based on similarity scores between the first skill and the first subset of skills and calculates a second normalized similarity score between the two skills based on similarity scores between the second skill and the second subset of skills. Finally, the system determines a sequence of the two skills based on a comparison of the normalized similarity scores and stores the sequence in association with the two skills.

### BACKGROUND

### Field

The disclosed embodiments relate to techniques for performing similarity-based sequencing of skills.

### Related Art

Online networks commonly include nodes representing individuals and/or organizations, along with links between pairs of nodes that represent different types and/or levels of social familiarity between the entities represented by the nodes. For example, two nodes in an online network may be connected as friends, acquaintances, family members, classmates, and/or professional contacts. Online networks may further be tracked and/or maintained on web-based networking services, such as client-server applications and/or devices that allow the individuals and/or organizations to establish and maintain professional connections, list work and community experience, endorse and/or recommend one another, promote products and/or services, and/or search and apply for jobs.

In turn, online networks may facilitate activities related to business, recruiting, networking, professional growth, and/or career development. For example, professionals may use an online network to locate prospects, maintain a professional image, establish and maintain relationships, and/or engage with other individuals and organizations. Similarly, recruiters may use the online network to search for candidates for job opportunities and/or open positions. At the same time, job seekers may use the online network to enhance their professional reputations, conduct job searches, reach out to connections for job opportunities, and apply to job listings. Consequently, use of online networks may be increased by improving the data and features that can be accessed through the online networks.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows the determination of a sequence of skills from similarity scores related to the skills in accordance with the disclosed embodiments.

FIG. 4 shows a flowchart illustrating the processing of data in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments provide a method, apparatus, and system for performing similarity-based sequencing of skills. In these embodiments, a skill sequence includes a directed path containing nodes representing skills and directed edges between the nodes that indicate the order in which the skills are commonly acquired. Thus, the skill sequence may be used to guide the acquisition of skills through education, employment, training, and/or practice.

In some embodiments, the ordering of skills in a skill sequence is determined based on pairwise comparisons of similarity among the skills. More specifically, similarity scores are calculated between pairs of skills based on semantic and/or usage-based relationships among a set of skills. For each of the skills, a number of “similar” skills that have the highest pairwise similarity scores with the skill are identified, and a direction between the skill and each of the similar skills is identified based on normalized values of the similarity scores.

For example, the skills may be mentioned in a number of documents, such as online network profiles, articles, course lists, and/or course curricula. A word embedding model is created from the documents, and similarity scores between pairs of skills is calculated using embeddings of the skills produced by the word embedding model. For each skill, a number of other skills are identified as similar to the skill based on a numeric threshold for the similarity scores and/or a ranking of the other skills by similarity score with the skill. Similarity scores between the other skills and the skill are then summed, and each similarity score is normalized by dividing the similarity score by the summed similarity scores. The normalized similarity scores for each pair of “highly similar” skills (e.g., two skills in which each skill is in the top 20 most similar skills to the other skill) are then compared, and a directed edge is created from the skill with the higher normalized similarity score to the skill with the lower normalized similarity score.

Directions associated with pairs of skills are then used to populate a directed graph of skills, which can be used to generate insights and/or recommendations related to professional development, education, career transitions, and/or training. Continuing with the above example, directed edges between pairs of skills may be combined into a graph, and paths in the graph are used to identify corresponding sequences of skills. The sequences may then be used to generate or validate course curricula for various fields of studies, recommend skills to learn or develop for various professions or job changes, identify a core set of “foundational” skills that are needed to learn or develop other skills, and/or generate other output or recommendations related to the sequences and/or the structure of the graph.

By generating sequences of skills based on comparisons of normalized similarity between pairs of skills, the disclosed embodiments identify the order in which the skills were learned. In turn, orderings of skills represented by the sequences can be used to generate recommendations and/or insights related to career planning, educational development, self-study, and/or professional training. Job seekers, recruiters, instructors, schools, educational technology products, employment products, recruiting products, and/or other entities involved in developing and/or using skills can use the recommendations and/or insights to improve skills-based job searches, job placement, and/or education.

In contrast, conventional techniques lack information related to the order in which skills are acquired or developed. Instead, employers, schools, job candidates, students, and/or other entities may teach, learn, develop, and/or assess skills in a sub-optimal manner, which may increase overhead and/or resource consumption by the entities. For example, an employer may attempt to teach a new skill to employees without verifying that the employees have acquired other skills that are necessary to mastering the new skill. When an employee attempts to learn the new skill without acquiring some or all of the other skills, the employee may struggle to learn or understand the new skill. As a result, the employee's performance may drop despite his/her efforts to learn the new skill, and the employer may expend significant time and resources in trying to teach the new skill to the employee without making much progress. Consequently, the disclosed embodiments may improve computer systems, applications, user experiences, tools, and/or technologies related to user recommendations, machine learning, employment, career planning, educational technology, recruiting, and/or hiring.

### Similarity-Based Sequencing of Skills

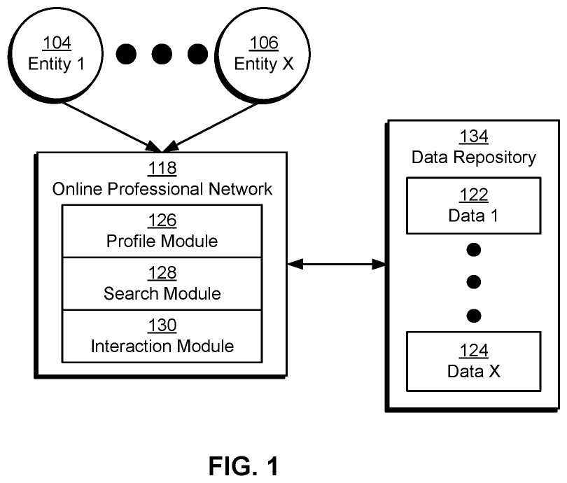

FIG. 1 shows a schematic of a system in accordance with the disclosed embodiments. As shown in FIG. 1, the system may include an online network 118 and/or other user community. For example, online network 118 may include an online professional network that is used by a set of entities (e.g., entity 1 104, entity x 106) to interact with one another in a professional and/or business context.

The entities may include users that use online network 118 to establish and maintain professional connections, list work and community experience, endorse and/or recommend one another, search and apply for jobs, and/or perform other actions. The entities may also include companies, employers, and/or recruiters that use online network 118 to list jobs, search for potential candidates, provide business-related updates to users, advertise, and/or take other action.

Online network 118 includes a profile module 126 that allows the entities to create and edit profiles containing information related to the entities' professional and/or industry backgrounds, experiences, summaries, job titles, projects, skills, and so on. Profile module 126 may also allow the entities to view the profiles of other entities in online network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online network 118 also includes a search module 128 that allows the entities to search online network 118 for people, companies, jobs, and/or other job- or business-related information. For example, the entities may input one or more keywords into a search bar to find profiles, job postings, job candidates, articles, and/or other information that includes and/or otherwise matches the keyword(s). The entities may additionally use an “Advanced Search” feature in online network 118 to search for profiles, jobs, and/or information by categories such as first name, last name, title, company, school, location, interests, relationship, skills, industry, groups, salary, experience level, etc.

Online network 118 further includes an interaction module 130 that allows the entities to interact with one another on online network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online network 118 may include other components and/or modules. For example, online network 118 may include a homepage, landing page, and/or content feed that delivers, to the entities, the latest posts, articles, and/or updates from the entities' connections and/or groups. Similarly, online network 118 may include features or mechanisms for recommending connections, job postings, articles, and/or groups to the entities.

In one or more embodiments, data (e.g., data 1 122, data x 124) related to the entities' profiles and activities on online network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online network 118 may be tracked and stored in a database, data warehouse, cloud storage, and/or other data-storage mechanism providing data repository 134.

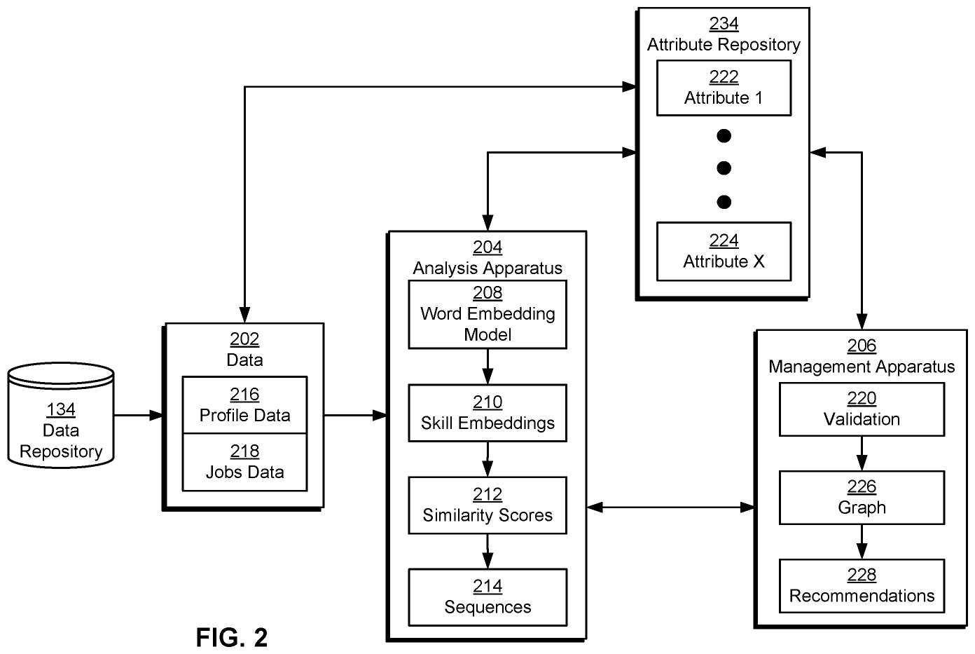

As shown in FIG. 2, data repository 134 and/or another primary data store may be queried for data 202 that includes profile data 216 for members of an online system (e.g., online network 118 of FIG. 1), as well as jobs data 218 for jobs that are listed and/or described within and/or outside the online system. Profile data 216 includes data associated with member profiles in the online system. For example, profile data 216 for an online professional network may include a set of attributes for each user, such as demographic (e.g., gender, age range, nationality, location, language), professional (e.g., job title, professional summary, employer, industry, experience, skills, seniority level, professional endorsements), social (e.g., organizations of which the user is a member, geographic area of residence), and/or educational (e.g., degree, university attended, certifications, publications) attributes. Profile data 216 may also include a set of groups to which the user belongs, the user's contacts and/or connections, and/or other data related to the user's interaction with the online system.

Attributes of the members from profile data 216 may be matched to a number of member segments, with each member segment containing a group of members that share one or more common attributes. For example, member segments in the online system may be defined to include members with the same industry, title, location, and/or language.

Connection information in profile data 216 may additionally be combined into a graph, with nodes in the graph representing entities (e.g., users, schools, companies, locations, etc.) in the online system. Edges between the nodes in the graph may represent relationships between the corresponding entities, such as connections between pairs of members, education of members at schools, employment of members at companies, following of a member or company by another member, business relationships and/or partnerships between organizations, and/or residence of members at locations.

Jobs data 218 includes structured and/or unstructured data for job listings and/or job descriptions that are posted and/or provided by members of the online system and/or external entities. For example, jobs data 218 for a given job or job listing may include a declared or inferred title, company, required or desired skills, responsibilities, qualifications, role, location, industry, seniority, salary range, benefits, and/or member segment.

Attribute repository 234 stores data that represents standardized, organized, and/or classified attributes (e.g., attribute 1 222, attribute x 224) in profile data 216 and/or jobs data 218. For example, skills in profile data 216 and/or jobs data 218 may be organized into a hierarchical taxonomy that is stored in attribute repository 234 and/or another repository. The taxonomy may model relationships between skills and/or sets of related skills (e.g., “Java programming” is related to or a subset of “software engineering”) and/or standardize identical or highly related skills (e.g., “Java programming,” “Java development,” “Android development,” and “Java programming language” are standardized to “Java”). In another example, locations in attribute repository 234 may include cities, metropolitan areas, states, countries, continents, and/or other standardized geographical regions. In a third example, attribute repository 234 includes standardized company names for a set of known and/or verified companies associated with the members and/or jobs. In a fourth example, attribute repository 234 includes standardized titles, seniorities, and/or industries for various jobs, members, and/or companies in the social network. In a fifth example, attribute repository 234 includes standardized degrees, fields of study, certificates, certifications, and/or licenses. In a sixth example, attribute repository 234 includes standardized time periods (e.g., daily, weekly, monthly, quarterly, yearly, etc.) that can be used to retrieve profile data 216, jobs data 218, and/or other data 202 that is represented by the time periods (e.g., starting a job in a given month or year, graduating from university within a five-year span, job listings posted within a two-week period, etc.).

In one or more embodiments, the system of FIG. 2 includes functionality to generate sequences 214 of skills, with each sequence representing a common, preferred, or “ideal” order in which to learn or acquire a number of related skills. For example, the system may generate sequences 214 of skills that can be learned along various educational programs, fields of study, and/or career paths. Within a given sequence, skills may be ordered by increasing difficulty and/or complexity. Moreover, skills that are earlier in the sequence may act as building blocks and/or requirements for learning skills that are later in the sequence.

An analysis apparatus 204 uses a word embedding model 208 to produce skill embeddings 210 of skills in profile data 216, jobs data 218, and/or other data 202 in data repository 134. For example, analysis apparatus 204 may train a word2vec model to generate skill embeddings 210 in a vector space based on occurrences and/or usage of standardized skills in attribute repository 234 in profile data 216 and/or jobs data 218. Analysis apparatus 204 may also, or instead, create word embedding model 208 using other documents that contain skills (e.g., standardized skills in attribute repository 234 and/or skills that can be mapped to standardized skills in attribute repository 234). For example, analysis apparatus 204 may include articles, course curricula, course lists for educational institutions, and/or course syllabuses as input to word embedding model 208. As a result, skills that share common contexts in documents inputted into word embedding model 208 may be closer to one another in the vector space of skill embeddings 210 than skills that are used in different contexts within the documents.

Analysis apparatus 204 uses skill embeddings 210 outputted by word embedding model 208 to produce similarity scores 212 between pairs of skills in attribute repository 234. For example, analysis apparatus 204 may calculate similarity scores 212 as cosine similarities between skill embeddings 210 for all pairs of standardized skills in attribute repository 234 and/or a subset of standardized skills in attribute repository 234 (e.g., standardized skills associated with a given function, industry, company, school, field, and/or other member segment).

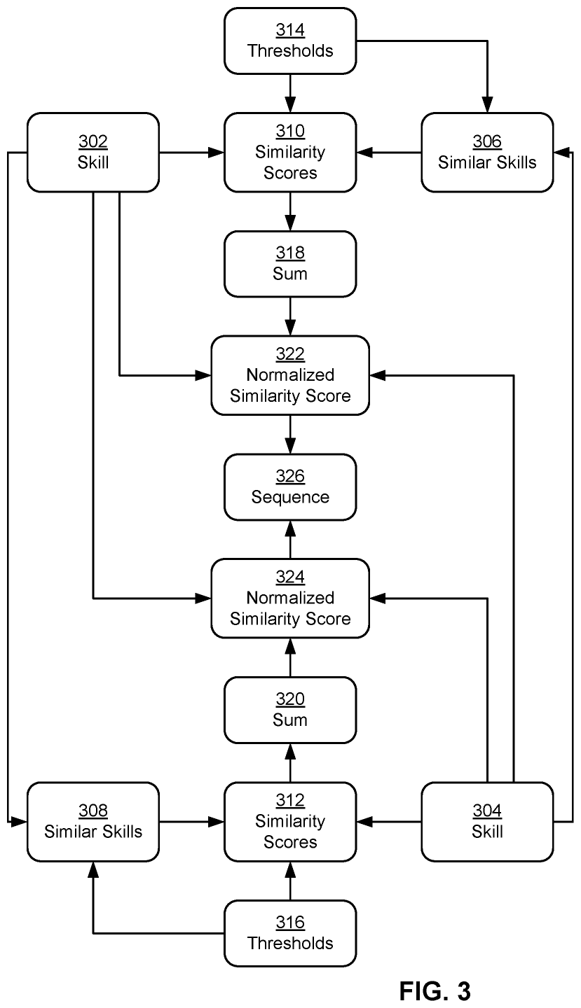

Analysis apparatus 204 generates sequences 214 of skills based on comparisons of similarity scores 212 between the pairs of skills. For example, analysis apparatus 204 may use similarity scores 212 between each skill and a number of other skills and identify a subset of the other skills as “similar” skills to the skill. Analysis apparatus 204 may use aggregated similarity scores 212 between the skill and the similar skills to calculate normalized similarity scores 212 between the skill and the similar skills. Analysis apparatus 204 may then generate sequences 214 of skills based on comparisons of normalized similarity scores 212 between some or all pairs of skill. Using normalized similarity scores to determine sequences of skills is described in further detail below with respect to FIG. 3.

A management apparatus 206 uses sequences 214 of skills from analysis apparatus 204 to create a graph 226 that captures sequential and/or ordinal relationships among the skills. For example, management apparatus 206 may create a directed graph 226 of standardized skills in attribute repository 234, with sequences 214 of two or more skills represented by directed edges connecting the skills in graph 226.

Management apparatus 206 additionally includes functionality to perform validation 220 of graph 226 based on additional analysis of profile data 216, jobs data 218, and/or other data 202 in data repository 134. One type of validation 220 performed by management apparatus 206 includes a cohort study of users represented by profile data 216, jobs data 218, and/or other data 202. The study may include a first cohort of users that possess only the first of two skills connected by a directed edge in graph 226, as well as a second cohort of users that possess only the second of the two skills. After a pre-specified period (e.g., a certain number of weeks, months, or years), the proportion of users that have learned the second skill in the first cohort is identified, along with the proportion of users that have learned the first skill in the second cohort. The higher proportion may then be used to identify and/or validate a sequence in which the skill initially possessed by users in the corresponding cohort is learned before the other skill.

Another type of validation 220 performed by management apparatus 206 includes analyzing changes to profile data 216, jobs data 218, and/or other data 202 over time. For example, management apparatus 206 may track skills that have been added to profile data 216 over time. If a higher proportion of member profiles add a second skill after a first skill has been added than add the first skill after the second skill has been added, a sequence that includes the first skill before the second skill may be identified and/or validated. In another example, management apparatus 206 may use salary increases associated with changes to profile data 216 to validate progressions along sequences 214 of skills in graph 226.

Validation 220 may thus be used to update, filter, and/or otherwise change nodes and/or edges in graph 226 in a way that improves the accuracy or relevance of sequences 214 in graph 226. For example, a sequence of two or more skills that is verified using analysis of data 202 in data repository 134 may be added to a “validated” version of graph 226. Conversely, a sequence of skills that is contradicted by data 202 in data repository 134 may be withheld from the validated version until additional validation 220 and/or analysis of the sequence can be performed.

Management apparatus 206 also generates recommendations 228 based on graph 226 and/or sequences 214 of skills in graph 226. For example, management apparatus 206 may identify a set of skills that are found only at the beginnings of sequences 214 in graph 226 and output the skills as “foundational” skills that serve as starting points for learning other skills in graph 226. In another example, management apparatus 206 may identify one or more sequences 214 of skills from a user's current skill set to a “target” skill set that is desired by the user and/or required for a job or career to which the user wishes to transition. Management apparatus 206 may output the identified sequences 214 and/or courses for learning skills in the sequences to the user as recommendations 228 that prepare the user for the desired job or career transition. In a third example, management apparatus 206 may create a course curriculum for one or more classes, with skills taught in the course curriculum ordered according to one or more sequences 214 of the skills in graph 226. In a fourth example, management apparatus 206 may recommend skills with greater numbers of outgoing edges in graph 226 to a user to expand the user's options for learning additional skills after the recommended skills are acquired.

By generating sequences 214 of skills based on comparisons of normalized similarity between pairs of skills, the system of FIG. 2 may identify the order in which the skills were learned. In turn, orderings of skills represented by sequences 214 can be used to generate recommendations 228 and/or insights related to career planning, educational development, self-study, and/or professional training. Job seekers, recruiters, instructors, schools, educational technology products, employment products, recruiting products, and/or other entities involved in developing and/or using skills can use recommendations 228 and/or insights to improve skills-based job searches, job placement, and/or education. In contrast, conventional techniques may lack information related to the order in which skills are acquired or developed. Instead, employers, schools, job candidates, students, and/or other entities may teach, learn, develop, and/or assess skills in a sub-optimal manner, which may increase overhead and/or resource consumption by the entities. Consequently, the system may improve computer systems, applications, user experiences, tools, and/or technologies related to user recommendations, machine learning, employment, career planning, educational technology, recruiting, and/or hiring.

Those skilled in the art will appreciate that the system of FIG. 2 may be implemented in a variety of ways. First, analysis apparatus 204, management apparatus 206, data repository 134, and/or attribute repository 234 may be provided by a single physical machine, multiple computer systems, one or more virtual machines, a grid, one or more databases, one or more filesystems, and/or a cloud computing system. Analysis apparatus 204 and management apparatus 206 may additionally be implemented together and/or separately by one or more hardware and/or software components and/or layers.

Second, skill embeddings 210, similarity scores 212, sequences 214, and/or graph 226 may be generated using a number of techniques. For example, the functionality of word embedding model 208 may be provided by a Large-Scale Information Network Embedding (LINE), principal component analysis (PCA), latent semantic analysis (LSA), deep learning model, and/or another technique that generates a low-dimensional embedding space from documents and/or terms. Multiple versions of word embedding model 208 may also be adapted to different types of skills and/or documents, or the same word embedding model 208 may be used to generate skill embeddings 210 for all skills and/or types documents. In another example, similarity scores 212 may be calculated using cross products, Jaccard similarities, Euclidean distances, and/or other measures of similarity or distance between skills. In a third example, sequences 214 and/or graph 226 may be created based on other types of relationships and/or metrics associated with the skills and/or groupings of skills.

Third, the system may be adapted to generate sequences of other types of attributes. For example, embeddings and/or similarity scores may be used to determine common or preferred sequences of attractions to visit, professional certifications to obtain, books to read, and/or languages to learn.

FIG. 3 shows the determination of a sequence 326 of skills 302-304 from similarity scores 310-312 related to skills 302-304 in accordance with the disclosed embodiments. As mentioned above, sequence 326 may represent a common, desired, or “ideal” order in which skills 302 and 304 are learned and/or acquired. A word embedding model (e.g., word embedding model 208 of FIG. 2) may be used to generate embeddings of a larger set of skills, and similarity scores (e.g., similarity scores 310-312) may be calculated from the embeddings of different pairs of skills, including skills 302-304.

One or more thresholds 314 are applied to similarity scores 310 associated with skill 302 to identify a set of similar skills 306 with respect to skill 302, and one or more additional thresholds 316 are applied to similarity scores 312 associated with skill 304 to identify a set of similar skills 308 with respect to skill 304. For example, thresholds 314-316 may include a limit to the number of similar skills 306 or 308 identified for each skill 302 or 304. Thresholds 314-316 may also, or instead, include a minimum similarity score calculated between each skill 302 or 304 and another skill. Thus, similar skills 306 may include up to a certain number of skills that have the highest similarity scores 310 with skill 302 and/or similarity scores 310 with skill 302 that exceed a numeric threshold. Likewise, similar skills 308 may include up to a certain number of skills that have the highest similarity scores 312 with skill 304 and/or similarity scores 312 with skill 304 that exceed a numeric threshold.

As shown in FIG. 3, sequence 326 may be identified for a given pair of skills 302-304 when each skill is found in the set of similar skills for the other skill. For example, skill 302 may be found in the set of similar skills 308 to skill 304, and skill 304 may be found in the set of similar skills 306 to skill 302, before skills 302-304 are added to a list of pairs of skills to be sequenced with respect to one another. Alternatively, sequence 326 may be determined for skills 302-304 when one of the skills appears in the set of similar skills for the other skill and/or independently of the presence of either skill in the set of similar skills for the other skill.

To determine sequence 326, a normalized similarity score 322 is calculated from the similarity score between skills 302-304 and a sum 318 of similarity scores 310 between skill 302 and similar skills 306. Another normalized similarity score 324 is calculated from the similarity score between skills 302-304 and a sum 320 of similarity scores 312 between skill 304 and similar skills 308. Normalized similarity scores 322-324 are then compared to determine the order of skills 302 and 304 in sequence 326.

For example, a similarity score between skills 302 and 304 may be divided by sum 318 to obtain normalized similarity score 322; the same similarity score between skills 302 and 304 may also be divided by sum 320 to obtain normalized similarity score 324. Thus, normalized similarity score 322 may represent a “probability” ranging from 0 to 1 that skill 302 precedes skill 304 in sequence 326, and normalized similarity score 324 may represent a “probability” ranging from 0 to 1 that skill 304 precedes skill 302 in sequence 326. Sequence 326 may then be selected to reflect the order of skills 302 and 304 associated with the higher normalized similarity score.

Continuing with the above example, skills 302-304 may have a similarity score of 0.75, sum 318 may be calculated by adding similarity scores 310 between skill 302 and the 20 most similar skills 306 to obtain a value of 10, and sum 320 may be calculated by adding similarity scores 312 between skill 304 and the 20 most similar skills 308 to obtain a value of 8. Normalized similarity score 322 may be calculated as 0.75/10, or 0.075, and normalized similarity score 324 may be calculated as 0.75/8, or 0.09375. Because normalized similarity score 324 is higher than normalized similarity score 322, skill 304 may be identified to precede skill 302 in sequence 326.

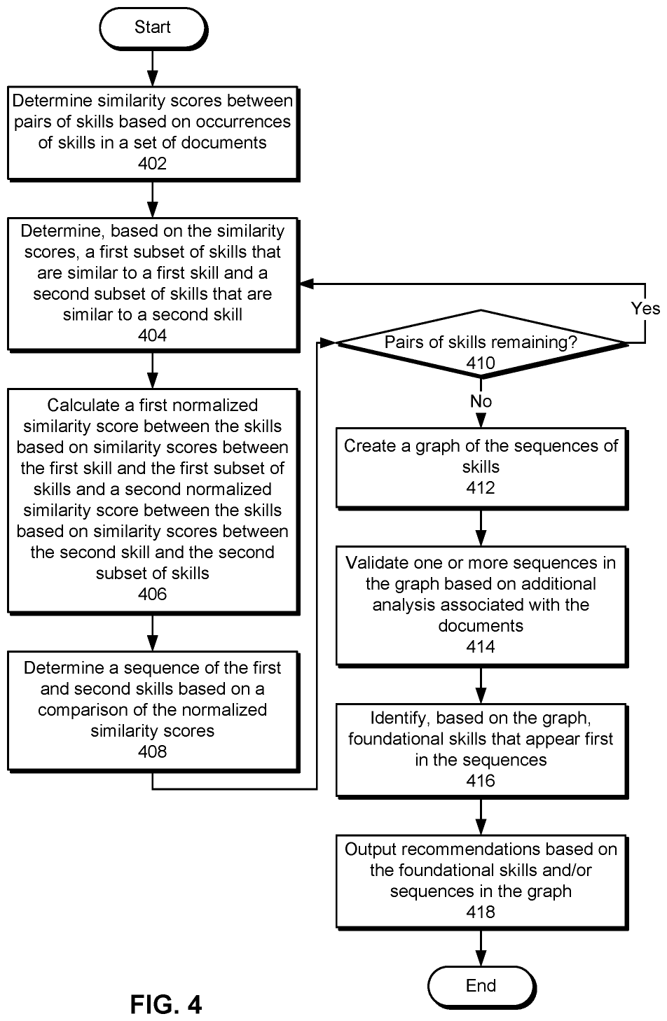

FIG. 4 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, similarity scores between pairs of skills are determined based on occurrences of the skills in a set of documents (operation 402). For example, a word embedding model may be created from documents such as online network profiles, jobs, articles, syllabuses, course curricula, and/or course lists. As a result, embeddings produced by the word embedding model may reflect semantic relationships among words in the documents, and similarity scores between pairs of skills may be calculated as cosine similarities from the corresponding embeddings.

Next, a first subset of skills that are similar to a first skill and a second subset of skills that are similar to a second skill are determined based on the similarity scores (operation 404). For example, each subset of skills may be identified to have the highest similarity scores with the corresponding skill. Each subset of skills may also include up to a maximum number of skills and/or skills having similarity scores with the corresponding skill that exceed a threshold.

A first normalized similarity score between the first and second skills is calculated based on similarity scores between the first skill and the first subset of the skills, and a second normalized similarity score is calculated between the first and second skills based on similarity scores between the second skill and the second subset of skills (operation 406). For example, a similarity score between the first and second skills may be divided by a first sum of the similarity scores between the first skill and the first subset of skills to produce the first normalized similarity score. Along the same lines, the similarity score may be divided by a second sum of the similarity scores between the second skill and the second subset of skills to produce the second normalized similarity score.

A sequence of the first and second skills is then determined based on a comparison of the normalized similarity scores (operation 408). For example, when the first normalized similarity score is greater than the second normalized similarity score, the first skill may be determined to precede the second skill in the sequence. When the second normalized similarity score is greater than the first normalized similarity score, the second skill may be determined to precede the first skill in the sequence.

Operations 404-408 may be repeated for remaining pairs of skills (operation 410). For example, normalized similarity scores and sequences may be determined for all pairs of skills in a given set of skills (e.g., a set of skills related to an industry, field of study, job function, and/or other attribute), pairs of skills with similarity scores that exceed a threshold, and/or pairs of skills that are identified to be “similar.”

A graph of the sequences of skills is created (operation 412), and one or more sequences in the graph are validated based on additional analysis associated with the documents (operation 414). For example, sequences of skills identified in operations 404-408 may be stored and/or represented using directed edges between the skills in the graph. The graph may then be validated using an analysis of a first cohort that initially possesses only the first skill and a second cohort that initially possesses only the second skill. The graph may also, or instead, be validated using analysis of skill additions, salary increases, and/or other changes to the documents over time.

Foundational skills that appear first in the sequences are identified based on the graph (operation 416), and recommendations are outputted based on the foundational skills and/or sequences in the graph (operation 418). For example, the foundational skills may be outputted as a set of “basic” skills that are required to learn other skills in a given domain. In another example, skills currently possessed by a user may be used to recommend individual skills and/or sequences of skills that can be learned by the user to progress along a career or educational path and/or switch to a different career or educational path. In a third example, one or more sequences of skills in the graph may be used to generate course curricula, syllabuses, and/or course lists for an educational entity.

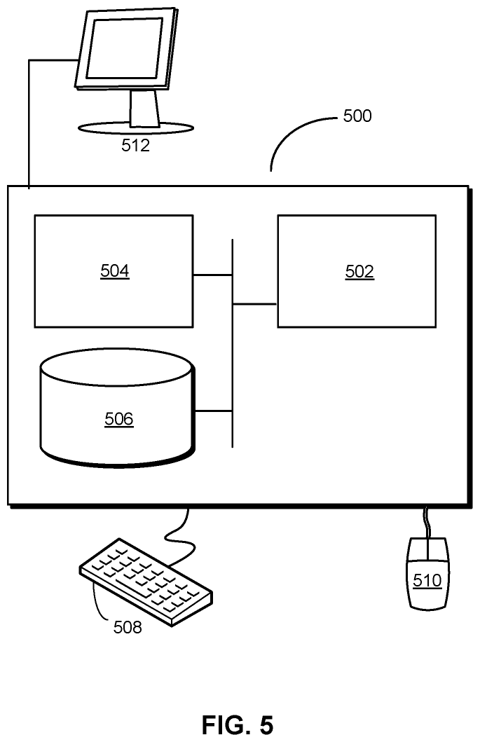

FIG. 5 shows a computer system 500 in accordance with the disclosed embodiments. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for processing data. The system includes an analysis apparatus and a management apparatus, one or more of which may alternatively be termed or implemented as a module, mechanism, or other type of system component. The analysis apparatus determines similarity scores between pairs of skills based on occurrences of the skills in documents. Next, the analysis apparatus determines, based on the similarity scores, a first subset of skills that is similar to a first skill and a second subset of skills that is similar to a second skill. The analysis apparatus then calculates a first normalized similarity score between the two skills based on similarity scores between the first skill and the first subset of skills and calculates a second normalized similarity score between the two skills based on similarity scores between the second skill and the second subset of skills. Finally, the analysis apparatus determines a sequence of the two skills based on a comparison of the normalized similarity scores, and the management apparatus outputs and/or stores the sequence in association with the two skills.

In addition, one or more components of computer system 500 may be remotely located and connected to the other components over a network. Portions of the present embodiments (e.g., analysis apparatus, management apparatus, data repository, attribute repository, online network, etc.) may also be located on different nodes of a distributed system that implements the embodiments. For example, the present embodiments may be implemented using a cloud computing system that determines sequences of skills based on data and/or activity associated with a set of remote entities.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
determining a set of similarity scores between pairs of skills in a set of skills based on occurrences of the set of skills in a set of documents;
determining, by one or more computer systems based on the set of similarity scores, a first subset of the skills that is similar to a first skill and a second subset of the skills that is similar to a second skill;
calculating, by the one or more computer systems, a first normalized similarity score between the first and second skills based on a first subset of the similarity scores between the first skill and the first subset of the skills;
calculating, by the one or more computer systems, a second normalized similarity score between the first and second skills based on a second subset of the similarity scores between the second skill and the second subset of skills;
determining, by the one or more computer systems, a sequence of the first and second skills based on a comparison of the first and second normalized similarity scores; and
storing the sequence in association with the first and second skills.

2. The method of claim 1, wherein determining the set of similarity scores between the pairs of skills in the set of skills based on occurrences of the set of skills in the set of documents comprises:
creating a word embedding model from the set of documents; and
calculating the set of similarity scores based on embeddings of the pairs of skills produced by the word embedding model.

3. The method of claim 2, wherein the documents comprise at least one of:
an online network profile;
a job;
an article;
a syllabus;
a curriculum; and
a course list.

4. The method of claim 2, wherein the set of similarity scores comprise a cosine similarity between a first embedding produced by the word embedding model and a second embedding produced by the word embedding model.

5. The method of claim 1, further comprising:
validating the sequence based on additional analysis associated with the set of documents.

6. The method of claim 5, wherein the additional analysis comprises at least one of:
a first analysis of a first cohort that possesses only the first skill and a second cohort that possesses only the second skill; and
a second analysis of changes to the documents over time.

7. The method of claim 6, wherein the changes to the documents comprise at least one of:
addition of a skill to a profile; and
a salary increase.

8. The method of claim 1, further comprising:
creating a graph comprising the skill sequence and additional skill sequences generated from additional normalized similarity scores between the pairs of skills; and
identifying, based on the graph, a third subset of skills that appear first in the skill sequence and the additional skill sequences.

9. The method of claim 1, wherein determining the first subset of the skills that is similar to the first skill comprises at least one of:
verifying that the first subset of the similarity scores between the first skill and the first subset of the skills exceeds a threshold; and
selecting, based on the first subset of the similarity scores, a pre-specified number of skills that have highest similarity scores with the first skill for inclusion in the first subset of the skills.

10. The method of claim 1, wherein calculating the first normalized similarity score and the second normalized similarity score comprises:
dividing a similarity score between the first and second skills by a first sum of the first subset of the similarity scores to produce the first normalized similarity score; and
dividing the similarity score by a second sum of the second subset of the similarity scores to produce the second normalized similarity score.

11. The method of claim 1, wherein determining the sequence of the first and second skills based on the comparison of the first and second normalized similarity scores comprises:
when the first normalized similarity score is greater than the second normalized similarity score, determining that the first skill precedes the second skill in the sequence; and
when the second normalized similarity score is greater than the first normalized similarity score, determining that the second skill precedes the first skill in the sequence.

12. The method of claim 1, wherein storing the sequence in association with the first and second skills comprises:
storing a directed edge representing the sequence of the first and second skills.

13. A system, comprising:
one or more processors; and
memory storing instructions that, when executed by the one or more processors, cause the system to:
determine a set of similarity scores between pairs of skills in a set of skills based on occurrences of the set of skills in a set of documents;
determine, based on the set of similarity scores, a first subset of the skills that is similar to a first skill and a second subset of the skills that is similar to a second skill;
calculate a first normalized similarity score between the first and second skills based on a first subset of the similarity scores between the first skill and the first subset of the skills;
calculate a second normalized similarity score between the first and second skills based on a second subset of the similarity scores between the second skill and the second subset of skills;
determine a sequence of the first and second skills based on a comparison of the first and second normalized similarity scores; and
store the sequence in association with the first and second skills.

14. The system of claim 13, wherein determining the set of similarity scores between the pairs of skills in the set of skills based on occurrences of the set of skills in the set of documents comprises:
creating a word embedding model from the set of documents; and
calculating the set of similarity scores based on embeddings of the pairs of skills produced by the word embedding model.

15. The system of claim 13, wherein the memory further stores instructions that, when executed by the one or more processors, cause the system to:
validate the sequence based on additional analysis associated with the set of documents.

16. The system of claim 13, wherein the memory further stores instructions that, when executed by the one or more processors, cause the system to:
create a graph comprising the skill sequence and additional skill sequences generated from additional normalized similarity scores between the pairs of skills; and
identify, based on the graph, a third subset of skills that appear first in the skill sequence and the additional skill sequences.

17. The system of claim 13, wherein determining the first subset of the skills that is similar to the first skill comprises at least one of:
verifying that the first subset of the similarity scores between the first skill and the first subset of the skills exceeds a threshold; and
selecting, based on the first subset of the similarity scores, a pre-specified number of skills that have highest similarity scores with the first skill for inclusion in the first subset of the skills.

18. The system of claim 13, wherein calculating the first normalized similarity score and the second normalized similarity score comprises:
dividing a similarity score between the first and second skills by a first sum of the first subset of the similarity scores to produce the first normalized similarity score; and
dividing the similarity score by a second sum of the second subset of the similarity scores to produce the second normalized similarity score.

19. The system of claim 18, wherein determining the sequence of the first and second skills based on the comparison of the first and second normalized similarity scores comprises:
when the first normalized similarity score is greater than the second normalized similarity score, determining that the first skill precedes the second skill in the sequence; and
when the second normalized similarity score is greater than the first normalized similarity score, determining that the second skill precedes the first skill in the sequence.

20. A non-transitory computer-readable storage medium storing instructions that when executed by a computer cause the computer to perform a method, the method comprising:
determining a set of similarity scores between pairs of skills in a set of skills based on occurrences of the set of skills in a set of documents;
determining, based on the set of similarity scores, a first subset of the skills that is similar to a first skill and a second subset of the skills that is similar to a second skill;
calculating a first normalized similarity score between the first and second skills based on a first subset of the similarity scores between the first skill and the first subset of the skills;
calculating a second normalized similarity score between the first and second skills based on a second subset of the similarity scores between the second skill and the second subset of skills;
determining a sequence of the first and second skills based on a comparison of the first and second normalized similarity scores; and
storing the sequence in association with the first and second skills.
